(19) United States
(12) Patent Application Publication
(10) Pub. No.: US 2008/0018208 A1
(43) Pub. Date: Jan. 24, 2008

(54) Stepping Motor

(76) Inventor: Roberto Zafferri, Lantau Island (HK)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/558,274

(22) Filed: Nov. 9, 2006

(30) Foreign Application Priority Data
Jul. 24, 2006 (CN) 200620130640.5

(51) Int. Cl. H02K 37/14; H02K 5/00

(52) U.S. Cl. 310/49 R; 310/40 MM

(57) ABSTRACT

A stepping motor comprises a stator, a rotor and a control circuit. The stator vane is provided at two sides thereof with coils electrically connected with the control circuit. The stator vane comprises three magnetic pole ends spaced by 120 degrees, which constitute a rotor hole for receiving the rotor; the rotor comprises a magnetic rotor and a rotor shaft. The magnetic rotor comprises several magnetic pole, wherein, the stator is a single stator vane integrally formed or a stator vane consisting of three vanes, the number of magnetic poles of the magnetic rotor is an even number greater than 2 and can not be divided exactly by 3. The stepping motor is solid, durable, and can be simply assembled. Further, the step angle can be reduced by increasing the number of the magnetic poles, and therefore, the stepping precision is increased.

### RELATED APPLICATIONS

The present application is related to and claims priority benefit of Chinese Application No. 200620130640.5 filed Jul. 24, 2006, the content of which is incorporated herein by reference.

### FIELD OF THE TECHNOLOGY

The present application for Utility Model relates to a stepping motor, and more particularly, to a low cost, high precision stepping motor.

### BACKGROUND OF THE TECHNOLOGY

Various types of stepping motors are usually needed in a variety of instrument devices or apparatuses for providing power. High precision stepping motors are particularly needed in electronic products such as instruments in vehicles, watches, etc.

Referring to FIG. 1, which is a schematic view of the structure of the stepping motor in the prior art. The stepping motor comprises a first stator vane 11, a second stator vane 12 and a rotor 13. The first stator vane 11 and the second stator vane 12 are disposed partly laminated. The first stator vane 11 has a first end surface 16 and a second end surface 18 at two ends thereof. The second stator vane 12 has a third end surface 17 and a fourth end surface 19 as its two end surfaces. The first end surface 11, the third end surface 17, the second end surface 18 and the fourth end surface 19 house the rotor 13 clockwise. The first stator vane 11 and the second stator vane 12 both comprise coils. Further, the rotor 13 has two magnetic poles with different polarity therein.

Magnetic fields are generated respectively between the first and second end surfaces 16,18 of the first stator vane 11 and the third and fourth end surfaces 17,19 of the second stator vane 12 when the coils of the first stator vane 11 and the second stator vane 12 are energized. The magnetic fields generate magnetic moments to the magnetic poles of the rotor 13 for rotating the rotor 13. Especially, when the direction of the current in the coils of the first stator vane 11 and the second stator vane 12 is changed alternatively, the alternate magnetic field generated can continuously drive the rotation of the rotor 13 and realize stepping rotation at 90 degrees.

However, the above said stepping motor comprises two stator vanes and they are laminated together. Therefore, the assembly of the stepping motor is difficult, the manufacture is complicated, and the manufacture cost is high. Further, the rotor 13 comprises only two magnetic poles, and therefore can realize only 90 degrees step angle and the stepping precision is poor.

### SUMMARY OF THE UTILITY MODEL

The object of the present Utility Model is to provide a low cost, high precision stepping motor so as to overcome the problem with the stepping motor of the prior art, which has high cost and poor stepping precision.

The technical scheme of the present Utility Model is as follows:

A stepping motor comprises a stator, a rotor and a control circuit. The stator vane is provided at two sides thereof with coils electrically connected with the control circuit. The stator vane comprises three magnetic pole ends spaced by 120 degrees, which constitute a rotor hole for receiving the rotor; the rotor comprises a magnetic rotor and a rotor shaft. The magnetic rotor comprises several magnetic poles, wherein, the stator is a single stator vane integrally formed or a stator vane consisting of three vanes, the number of magnetic poles of the magnetic rotor is an even number greater than 2 and can not be divided exactly by 3.

The adjacent magnetic poles of the magnetic rotor have opposite polarity, that is, a north pole and a south pole.

The stepping motor has a step angle that is the quotient of 180 degrees divided by the number of the magnetic rotors.

The number of magnetic poles of the rotor is 4, 8, 10, 14, 16, 20, 22, 26, 28, 32, 34, 38.

The shapes of both the rotor hole and the rotor received by the rotor hole in vertical section are concentric circles.

The arc length of the magnetic pole end surface of the stator vane is greater than that of the single magnetic pole of the rotor but less that that of the adjacent two magnetic poles.

The respective magnetic pole ends of the stator vanes are separated from each other.

The adjacent magnetic pole ends of the stator vanes are connected by narrow grooves, wherein, the distances from the end of the narrow grooves and the center of the rotor shaft are identical.

The magnetic rotor is a permanent magnetic iron rotor.

In contrast to the prior art, the stepping motor of the present Utility Model is a single stator vane integrally formed, or a stator vane consisting of three vanes in one plane, and therefore it can be manufactured simply with low cost. The magnetic rotor of the stepping motor comprises several magnetic poles, the number of which is an even number, which is greater than 2 but can not be divided exactly by 3. The minimum step angle thereof is the quotient of 180 degrees divided by the number of magnetic poles. Therefore, the stepping precision can be continuously increased by increasing the number of the magnetic poles.

### DESCRIPTION OF THE DRAWINGS

FIG. 1 is a schematic structural view of a stepping motor in the prior art;

FIG. 2 is a schematic structural view of the first embodiment of the stepping motor of the present Utility Model;

FIG. 3 is a schematic view showing the stepping cycle of the stepping motor in FIG. 2;

FIG. 4 is a schematic structural view of the second embodiment of the stepping motor of the present Utility Model;

FIG. 5 is a schematic view showing the stepping cycle of the stepping motor in FIG. 4.

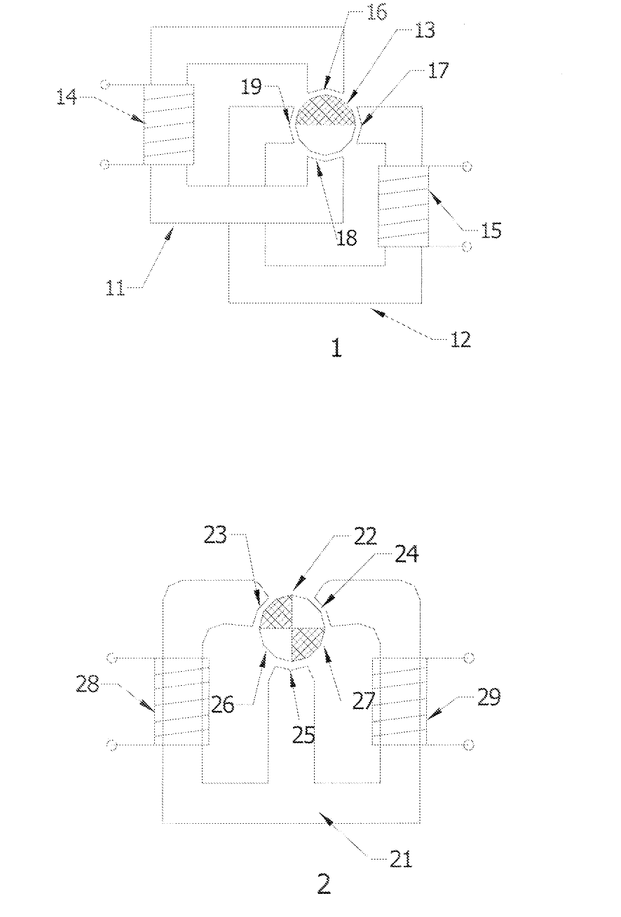

### DETAILED DESCRIPTION OF THE PREFERRED EMBODIMENTS

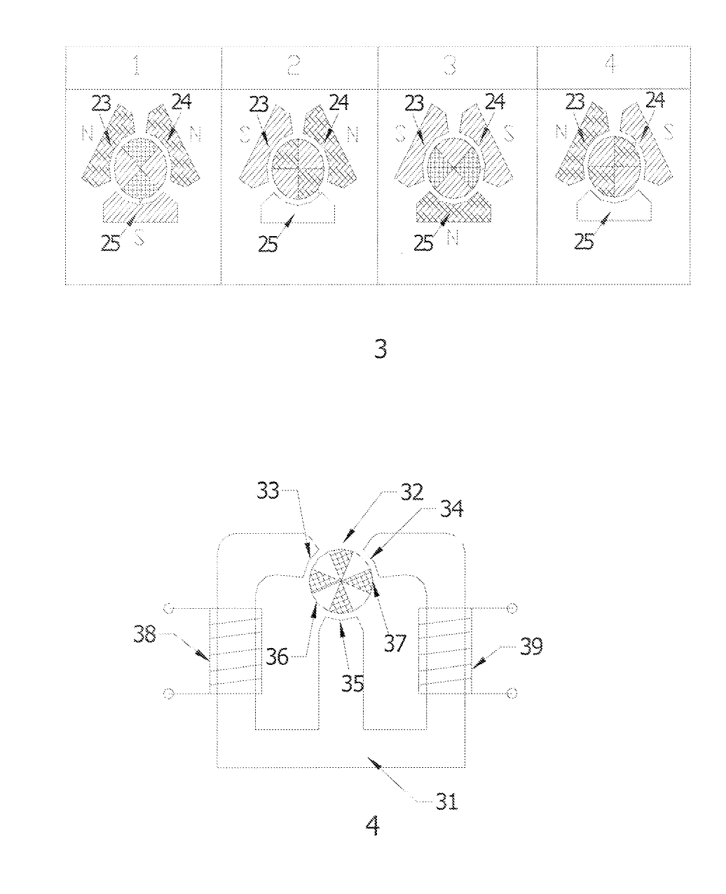

Referring to FIG. 2, which is a schematic structural view of the first embodiment of the stepping motor of the present Utility Model. The stepping motor comprises a stator, a rotor and a control circuit (not showing in the drawing).

The stator is a single stator vane 21 formed integrally from soft magnetic material. The stator vane 21 is provided at two sides thereof with a first coil 28 and a second coil 29, which both electrically connected with the control circuit. There is a rotor hole in the center of the stator vane 21 for receiving the rotor. The shape of the rotor hole in section is a concentric circle with the shape of the rotor in section. The stator vane 21 comprises three magnetic pole end surfaces spaced from each other with 120 degrees. They are first, second, and third magnetic pole end surfaces 23, 24, and 25, respectively. The first, second and third magnetic pole end surfaces 23, 24 and 25 are arc surfaces of identical sizes, and receive the rotor.

The rotor comprises a magnetic rotor 22 and a rotor shaft. The magnetic rotor 22 is made of permanent magnetic iron and comprises fourth magnetic poles disposed radially. The adjacent magnetic poles have opposite polarity, that is, south pole 26 and north pole 27 disposed alternatively. Further, the side of the magnetic pole, which faces the magnetic pole end surface of the stator vane 21 is an arc surface. The end of the rotor shaft is provided with a gear for transmitting the rotation movement of the rotor shaft.

Further, the arc length of the respective magnetic pole end surfaces 23, 24 and 25 of the stator vane 21 is between that of a magnetic pole and that of the two adjacent magnetic poles.

Referring to FIG. 3, which is a schematic view showing the stepping cycle of the stepping motor of the present embodiment. When the stepping motor operates, the drive process of the rotor is divided into four stages as a drive cycle.

In the first stage, the first coil 28 and the second coil 29 are provided with current in the same direction by the control circuit. Due to the electromagnetic induction of the coil, the first magnetic pole end surface 23 and the second magnetic pole end surface 24 are north poles, and the third magnetic pole end surface 25 is south pole. The four magnetic poles of the magnetic rotor 22 are two south poles 26 and two north poles 27 disposed alternatively. Therefore, the first magnetic pole end surface 23 and the second magnetic pole end surface 24 would absorb the magnetic pole 26 adjacent to them, and the third magnetic pole end surface 25 would absorb the north pole 27 of the rotor adjacent to it. Therefore, magnetic moment is generated to the magnetic rotor 22, for driving the anticlockwise rotation of the rotor 22 with a step angle of 45 degrees.

In the second stage, the direction of current in the first coil 28 is change by the control circuit so that the first magnetic pole end surface 23 becomes south pole, the second magnetic pole end surface 24 remains as north pole, and the third magnetic pole end surface 25 loses its polarity. In this way, the first magnetic pole end surface 23 absorbs the north pole 27 of the rotor most adjacent to it, and the second magnetic pole end surface 24 absorbs nearest south pole 26 so that magnetic moment is generated to make the magnetic rotor 22 rotate anticlockwise with a step angle remaining as 45 degrees and depart the original position by 90 degrees.

In the third stage, the direction of current in the second coil 29 is changed by the control circuit, and the direction of current in the second coil 28 remains unchanged. The polarity of the first magnetic pole end surface 23 remains as south pole; the second magnetic pole end surface 24 becomes south pole under the electromagnetic induction; and the third magnetic pole end surface 25 becomes north pole. In this way, the third magnetic pole end surface 25 absorbs the north pole 26 of the rotor 22 adjacent to it, and the first and second magnetic pole end surfaces 23 and 24 absorb north pole 27 of the rotor 22 adjacent them. Therefore, the magnetic moment is generated to make the magnetic rotor 22 rotate anticlockwise with a step angle of 45 degrees and depart the original position by 135 degrees.

In the fourth stage, the direction of current in the first coil 28 is changed by the control circuit so that the first magnetic pole end surface 23 becomes north pole under electromagnetic induction; the second magnetic pole end surface 24 remains unchanged as south pole; and the third magnetic pole end surface 25 loses its polarity. In this way, the first magnetic pole end surface 23 absorbs the south pole 26 of the rotor 22 adjacent to it, and the second magnetic pole end surfaces 24 absorbs north pole 27 of the rotor 22 adjacent to it. Therefore, the magnetic moment is generated to make the magnetic rotor 22 rotate anticlockwise with an angle of 45 degrees and depart the original position by 180 degrees.

The magnetic rotor 22 returns to its original state after rotating 180 degrees and therefore capable of repeating the first, second, third and fourth stages, so that the magnetic rotor 22 continuously rotate in one direction.

The step angle of the stepping motor, 45 degree, which is generated by changing the direction of the current in the coil at each stage, is a quotient of 180 degrees divided by the number of the magnetic poles of the rotor 22.

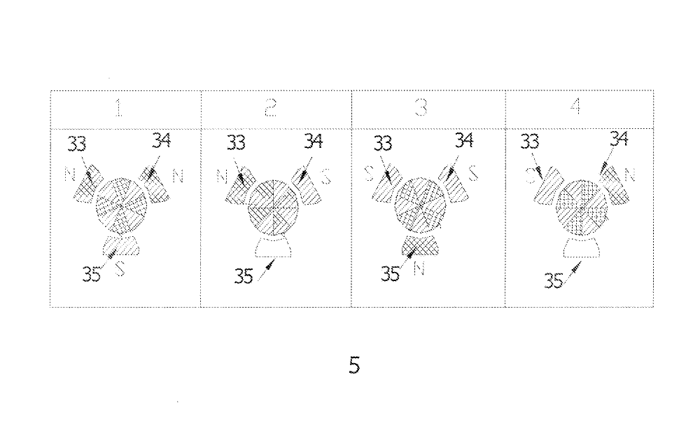

Referring to FIG. 4, which is a structural schematic view of the second embodiment of the stepping motor of the present Utility Model. The structure of the second embodiment is similar with that of the first embodiment of the stepping motor. The stepping motor on the second embodiment also comprises a stator 31, a rotor 32 and a control circuit. The stator vane 31 comprises three magnetic pole end surfaces spaced from each other at 120 degrees and two coils. The three magnetic pole end surfaces are respectively the first, second, and third magnetic pole end surfaces 33, 34, and 35. The two coils are respectively the first coil 38 and the second coil 39, which are disposed symmetrically at two sides of the stator vane 31. However, the magnetic rotor 32 comprises 8 magnetic poles disposed radially. The adjacent magnetic poles have opposite polarity, that is, four south poles 36 and four north poles 37 disposed alternatively. Further, the first, second, and third magnetic pole end surfaces 33, 34 and 35 receive the magnetic rotor 32 having eight magnetic poles.

Referring to FIG. 5, which is a schematic view showing the stepping cycle of the stepping motor in FIG. 4. The stepping cycle of the stepping motor is also divided into four stages.

In the first stage, the first coil 38 and the second coil 39 is supplied with current through control circuit, so that the first magnetic pole end surface 33 of the stator vane 31 is as north pole, the second magnetic pole end surface 34 also is north pole, and the third magnetic pole end surface 35 is south pole. The third magnetic pole end surface 35 would absorb the north pole 37 of the magnetic rotor 32 adjacent to it, and the first magnetic pole end surface 33 and the second magnetic pole end surface 34 would absorb the south pole 36 of the magnetic rotor adjacent to them. Therefore, the first, second and third magnetic pole end surfaces 33, 34 and 35 of the stator vane 31 generate magnetic moment to the magnetic rotor 32, for driving the anticlockwise rotation of the rotor 32 with a step angle of 22.5 degrees, that is, the stepping precision is 22.5 degrees.

In the second stage, the direction of current in the second coil 39 is changed through the control circuit, but the direction of the current in the first coil 38 remains unchanged. Due to electromagnetic induction, the first magnetic pole end surface 33 of the stator vane 31 acts as north pole; the second magnetic pole end surface 34 is south pole; and the third magnetic pole end surface 35 loses its polarity. In this way, the first magnetic pole end surface 33 absorbs the south pole 36 of the rotor adjacent to it, and the second magnetic pole end surface 34 absorbs north pole 37 of the rotor adjacent to it, so that magnetic moment is generated to make the magnetic rotor 32 rotate anticlockwise with a angle 22.5 degrees and depart the original position by 45 degrees.

In the third stage, the direction of current in the first coil 38 through the control circuit, and the direction of current in the second coil 39 remains unchanged. Due to electromagnetic induction, the first magnetic pole end surface 33 of the stator vane 31 becomes south pole; the second magnetic pole end surface 34 remains as south pole; and the third magnetic pole end surface 35 becomes north pole. The third magnetic pole end surface 35 absorbs the south pole 36 of the rotor adjacent to it, and the first and second magnetic pole end surfaces 33 and 34 absorb north pole 37 of the rotor adjacent to it, so that magnetic moment is generated to the rotor 32 for making the magnetic rotor 32 rotate anticlockwise with another angle 22.5 degrees, and thus depart the original position by 67.5 degrees.

In the fourth stage, the direction of current in the second coil 39 through the control circuit, and the direction of current in the first coil 38 remains unchanged. Due to electromagnetic induction, the first magnetic pole end surface 33 of the stator vane 31 becomes south pole; the second magnetic pole end surface 34 remains as north pole; and the third magnetic pole end surface 35 loses its polarity. Therefore, the first magnetic pole end surface 33 absorbs the north pole 37 of the rotor adjacent to it, and the second magnetic pole end surfaces 34 absorbs south pole 36 of the rotor adjacent to it, so that magnetic moment is generated to make the rotor 32 rotate anticlockwise with angle 22.5 degrees, and thus depart the original position by 90 degrees.

However, in the present embodiment, the rotor 32 has eight magnetic poles, with four south poles 36 and four north poles 37 disposed radially and alternatively. Therefore, the rotor 32 returns to its original state after rotating 90 degrees and repeat the first, second, third and fourth stages so as to make the rotor 32 continuously rotate in one direction.

Further, the step angle of the stepping motor, 22.5 degrees, which is generated by changing the direction of the current in the coil at each stage, is a quotient of 180 degrees divided by the number of the magnetic poles of the rotor.

The stepping motor of the present utility model increases the stepping precision by increasing the number of magnetic poles of the magnetic rotor, and the minimum step angle thereof is a quotient of 180 degrees divided by the number of the magnetic poles of the magnetic rotors. Therefore, the stepping precision of the stepping motor can be continuously increased by increasing the number of the magnetic poles of the rotor. However, since the stator vane of the present utility model is provided with three magnetic pole end surfaces, it generates magnetic moment to the rotor by changing its magnetic pole so as to drive the rotation of the rotor. However, to prevent the condition of equilibrium of magnetic moments, the number of magnetic poles of the rotor is an even number greater than 2 and can not be divided exactly by 3. Therefore, the number of the magnetic poles can be 4, 8, 10, 14, 16, 20, 22, 26, 28, 32, 34 and 38, etc. When the number of the magnetic poles of the rotor increases, the stepping behaviors of the stepping motor are similar, that is, they all realize the stepping by driving the rotation of the magnetic rotor by the magnetic pole end surfaces through changing the direction of the current in coils in turn. In addition, the stator of the present utility model is a single stator vane formed integrally and can be manufactured simply with low cost.

The following is a further improvement of the stepping motor of the present Utility Model. The three magnetic pole end surfaces of the stator vane can be separated by three narrow grooves spaced by 120 degrees with each other. The three narrow grooves are disposed along the radial direction of the rotor. The two ends of each narrow groove are connected with the stator vane, and the connecting portion is thin, where the magnetic field is saturated and thus generates magnetic moment to the rotor. The distances between the ends of the narrow grooves to the axis of the rotor are identical. In addition, the stator can also be a stator vane consisting of three vanes in the same plane, which correspond to the three magnetic pole end surfaces respectively. Therefore, it can be manufactured simply and low costly.

In summary, the stator of the stepping motor of the present Utility Model is a single stator vane integrally formed, or a stator vane consisting of three vanes, and therefore it can be manufactured simply with low cost. The number of the magnetic poles of he magnetic rotor of the stepping motor is an even number, which is greater than 2 but can not be divided exactly by 3. The minimum step angle thereof is the quotient of 180 degrees divided by the number of magnetic poles. Therefore, the stepping precision can be continuously increased by increasing the number of the magnetic poles. Therefore, the stepping motor of the present Utility Model can be manufactured simply and low costly, and it has high stepping precision. Also, according to the practical requirement, the stepping precision can be continuously increased by increasing the number of the magnetic poles of the rotors.

1. A stepping motor comprising a stator, a rotor and a control circuit, the stator vane being provided at two sides thereof with coils electrically connected with the control circuit; the stator vane comprising three magnetic pole ends spaced by 120 degrees, which constitute a rotor hole for receiving the rotor; the rotor comprising a magnetic rotor and a rotor shaft; the magnetic rotor comprising several magnetic poles, wherein, the stator is a single stator vane integrally formed or a stator vane consisting of three vanes, the number of magnetic poles of the magnetic rotor being an even number which is greater than 2 and can not be divided exactly by 3.

2. The stepping motor according to claim 1, wherein the adjacent magnetic poles of the magnetic rotor have opposite polarity, and they are respectively north pole and south pole.

3. The stepping motor according to claim 2, wherein the step angle is the quotient of 180 degrees divided by the number of the magnetic rotors.

4. The stepping motor according to claim 3, wherein the number of magnetic poles of the magnetic rotor is 4, 8, 10, 14, 16, 20, 22, 26, 28, 32, 34, 38.

5. The stepping motor according to claim 3, wherein the shapes of the rotor hole and the rotor received by the rotor hole in vertical section are concentric circles.

6. The stepping motor according to claim 5, wherein the arc length of the magnetic pole end surface of the stator vane is greater than that of the single magnetic pole of the rotor but less than that of the adjacent two magnetic poles.

7. The stepping motor according to claim 6, wherein the respective magnetic pole ends of the stator vane are separated from each other.

8. The stepping motor according to claim 6, wherein the adjacent magnetic pole ends of the stator vane are connected by narrow grooves, wherein, the distances from the ends of the narrow grooves to the center of the rotor shaft are identical.

9. The stepping motor according to claim 7 or 8, wherein the magnetic rotor is a permanent magnetic iron rotor.
